(19) United States
(12) Patent Application Publication
(10) Pub. No.: US 2014/0246929 A1
(43) Pub. Date: Sep. 4, 2014

(54) HIGH THERMAL CONDUCTIVITY INSULATION FOR ELECTRICAL MACHINES

(71) Applicant: GENERAL ELECTRIC COMPANY, Schenectady, NY (US)

(72) Inventors: Stephen Frank Francese, Malta, NY (US); Jeffrey David Sheaffer, Glenville, NY (US); Leonard Paul Squillacioti, Saratoga Springs, NY (US); David John Wardell, Ballston Spa, NY (US)

(73) Assignee: General Electric Company, Schenectady, NY (US)

(21) Appl. No.: 13/783,687

(22) Filed: Mar. 4, 2013

(51) Int. Cl. H02K 9/22; H02K 3/30

(52) U.S. Cl. CPC H02K 9/22; H02K 3/30
USPC 310/52

(57) ABSTRACT

A stator bar includes a plurality of conductors and an insulation layer positioned about the plurality of conductors. The insulation layer includes multiple layers, and the multiple layers have one or more electrically insulating layer and one or more thermally conductive layer.

### TECHNICAL FIELD

The present application relates generally to insulating systems for electrical machines and more particularly relates to improving the thermal conductivity of insulation used with stator bar components through the addition of high thermal conductivity fillers.

### BACKGROUND OF THE INVENTION

Insulation materials for electrical machines such as generators, motors, and transformers generally include a glass cloth and/or a combination of a glass cloth, a resin binder, a mica paper, and similar materials. Such insulating materials generally need to have the mechanical and the physical properties that can withstand the various electrical rigors of the electrical machines while providing adequate insulation. In addition, the insulation materials should withstand extreme operating temperature variations and provide a long design life.

In recent years, the thermal conductivity of general insulation has improved from about 0.3 W/mK to about 0.5 W/mK (Watts per meter per degrees Kelvin) via the addition of high thermal conductivity fillers. Specifically with respect to stator bars, however, E-glass (electrical fiberglass) generally is used to insulate the conductors, as a vertical separator, and as a backer in insulating tapes. Such E-glass may have a thermal conductivity of about 0.99 W/mK. Similarly, Dacron™ (a registered trademark of Invista North America S.A.R.L. Corporation) glass also may be used. Dacron™ glass may have a thermal conductivity of about 0.4 W/mK.

By reducing the thermal resistance of the stator bar components, improved heat transfer may be obtained between the stator bar conductors and the stator core. Specifically, the current density of the copper conductor may be increased by effectively cooling the conductors. There is thus a desire for even further thermal conductivity improvements so as to produce more power and/or a higher efficiency for existing electrical machines, or for the production of new units of smaller size that would have more economical cost.

### BRIEF DESCRIPTION OF THE INVENTION

According to one aspect of the present invention, a stator bar is provided that includes a plurality of conductors and an insulation layer positioned about the plurality of conductors. The insulation layer includes multiple layers, and the multiple layers have one or more electrically insulating layer and one or more thermally conductive layer.

According to another aspect of the present invention, an insulating system is provided having an insulation layer positioned about one or more conductors. The insulation layer includes multiple layers, and the multiple layers have one or more electrically insulating layer and one or more thermally conductive layer.

According to yet another aspect of the present invention, an insulating system is provided having an insulation layer positioned about one or more conductors. The insulation layer has one or more thermally conductive layer. The insulation layer is configured as turn insulation, and the insulation layer is located between individual turns and/or around individual turns.

These and other features of the present invention will become apparent to one of ordinary skill in the art upon the review of the following detailed description when taken in conjunction with the several drawings and the following claims.

### BRIEF DESCRIPTION OF THE DRAWINGS

FIG. 1 is a perspective view of a stator bar, according to an aspect of the present invention;

FIG. 2 is a side cross-sectional view of a stator coil, according to an aspect of the present invention;

FIG. 3 illustrates a cross-sectional view of an insulation layer, according to an aspect of the present invention;

FIG. 4 illustrates a cross-sectional view of an insulation layer, according to an aspect of the present invention;

FIG. 5 illustrates a cross-sectional view of an insulation layer, according to an aspect of the present invention;

FIG. 6 is a side cross-sectional view of a Roebel-type stator bar, according to an aspect of the present invention; and

FIG. 7 is a side cross-sectional view of a two turn Roebel-type stator bar, according to an aspect of the present invention.

### DETAILED DESCRIPTION

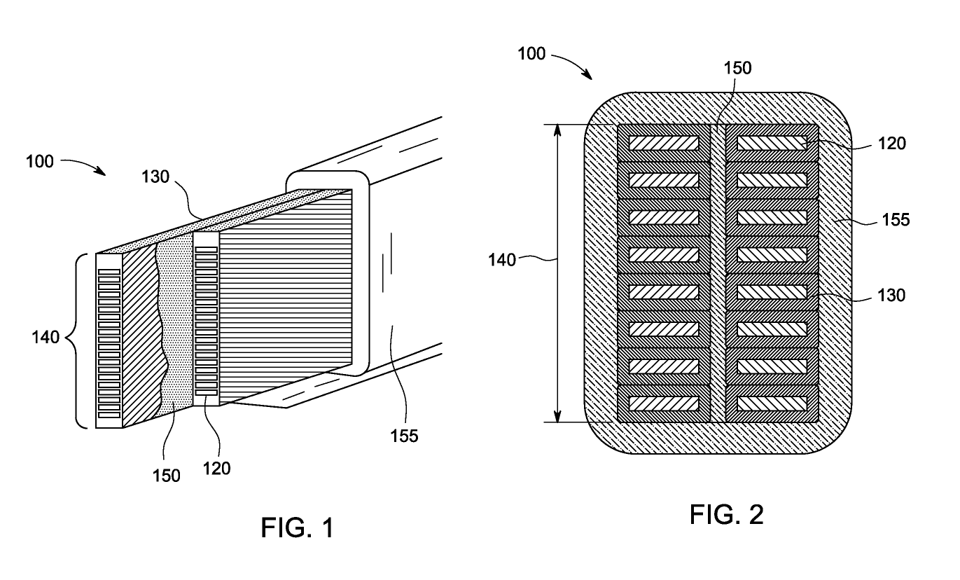

Referring now to the drawings, in which like numerals refer to like elements throughout the several views, FIG. 1 and FIG. 2 show a stator coil or bar 100 as is described herein. As described above, the stator coil or bar 100 may be used with electrical machines as is known in the art. An electrical machine generally has multiple stator coils or bars 100. The multiple stator coils or bars 100 may be identical and may be disposed upon or about each other.

Generally described, each stator coil or bar 100 may include a number of conductors 120. The conductors 120 may be made out of copper, copper alloys, aluminum, or similar materials. A layer of conductor insulation 130 may separate individual conductors 120. In this example, the conductor insulation 130 may include a typical E-Glass, Daglass, or a similar type of glass material. The E-Glass may be a low alkali borosilicate fiberglass with good electro-mechanical properties and with good chemical resistance. E-Glass, or electrical grade glass, has excellent fiber forming capabilities and is used as the reinforcing phase in fiberglass. The E-Glass may have a thermal conductivity of about 0.99 W/mK. The Daglass may be a yarn with a mixture of polyester and glass fibers. The Daglass may have a thermal conductivity of about 0.4 W/mK. A glass cloth made from the E-Glass, the Daglass, or from similar types of materials may have any desired woven densities, weights, thicknesses, strengths, and other properties.

Referring to FIG. 2, the stator coil or bar 100 includes two tiers (stacks) 140 of the conductors 120. Any number of tiers 140 or stacks may be used. The tiers 140 may be separated by a vertical separator 150. Typical vertical separators 150 may include paper, felt, or a glass fabric that is treated with a resin that, when cured, flows and bonds the tiers/stacks 140 together. The separators 150 also provide added electrical insulation between tiers 140. The tiers 140 also may be surrounded by a layer of ground wall insulation 155. As described above, the ground wall insulation 155 commonly may be constructed of multiple layers of mica paper, a glass cloth or unidirectional glass fibers, and a resin binder. The ground wall insulation 155 generally is in the form of multiple layers of a mica composite tape that is wrapped around the tiers/stacks 140.

To improve the capability of the armature winding 100 of an electrical machine one can take several approaches. One option is to increase the voltage capability of the insulation, resulting in thinner insulation build for the same voltage rating. This option has the benefits of thinner ground wall insulation that allows for improved heat flow from conductors to the stator core which could allow for increased current through conductors with no change in the thermocouple reading allowing for improved efficiency or output. Another benefit of thinner ground wall insulation would allow for additional conductor volume combined with improved heat transfer via thinner ground wall insulation that allows increased current carrying capability to increase efficiency or power output for same size bar or coil. Another benefit of thinner ground wall insulation would allow for reduced bar or coil size with the same conductor volume and the added potential to reduce size of the electrical machines.

An aspect of the present invention improves the thermal conductivity of the armature bar ground wall insulation by the application of a fabric material treated with resin containing high thermal conductivity filler during the process of applying the main ground wall insulation tape. This coated fabric substrate can be utilized with multiple insulation systems and applied regardless of the stator bar or coil process type. The goal is to utilize this new coated material with hydrostatically cured, press cured, or vacuum pressure impregnation (VPI) ground wall insulation systems. The ground wall insulation can include a coated and impregnated fabric having resin containing a high thermal conductivity filler such as boron nitride with a formulation that is compatible with multiple or specific cure chemistries and mica tape constructions. The percentage of this material versus the rest of the ground wall insulation may be between about 10 and about 50%, trading off the impact to dielectric properties. Amounts above or below this range may be used as desired in the specific application.

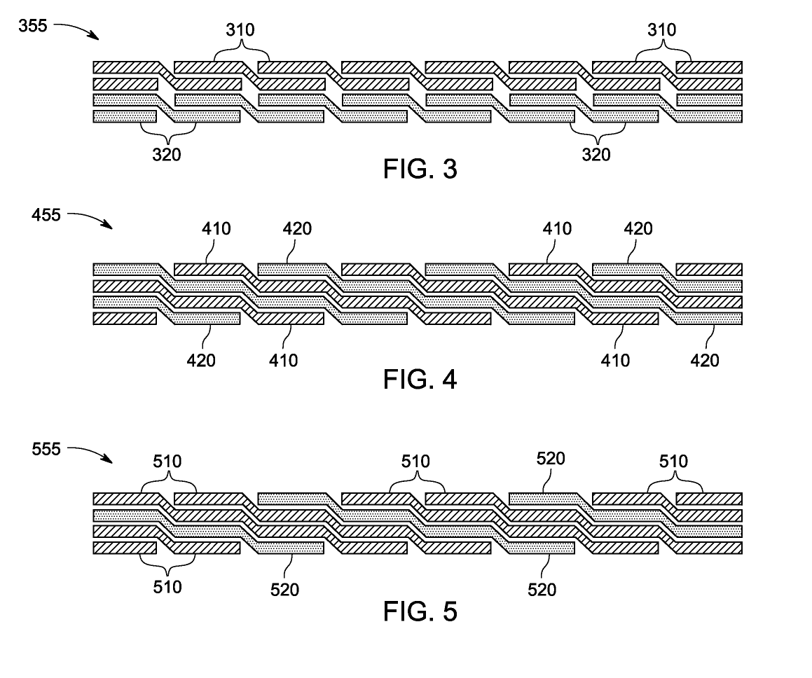

FIG. 3 illustrates a cross-sectional view of an insulation layer 355 (two tape layers), that could be used as part of the construction of the ground wall insulation 155 as shown in FIG. 2, according to an aspect of the present invention. The insulation layer 355 is comprised of multiple layers, and these layers have various characteristics. For example, an electrically insulating layer 310 may be comprised of a mica paper or mica composite tape. The electrically insulating layer 310 may include mica or fiberglass combined with films, yarns, mats or woven fabrics or combinations thereof to support the mica during application. A resin binder may be used to bond and fill spaces within the individual layers of electrically insulating layer 310. The main purpose of the electrically insulating layer 310 is to be electrically insulating, and this layer does not have high thermal conductivity. The electrically insulating layer 310 may be formed of one or more electrically insulating layer.

A thermally conductive layer 320 may be a fabric component treated with resin containing high thermal conductivity filler. The high thermal conductivity filler may be at least one of boron nitride (BN), aluminum oxide (Al2O3), aluminum nitride (AlN), silicon nitride (Si3N4), magnesium oxide (MgO), zinc oxide (ZnO), strontium titanate (SrTiO3), titanium dioxide (TiO2), silica (SiO2), or diamond (C), or combinations thereof. As two examples only, aluminum oxide (Al2O3) has a thermal conductivity of about 20 W/mK, and boron nitride (BN) has a thermal conductivity of about 600 W/mK. The thermally conductive layer 320 may be comprised of a glass fabric coated with a resin containing the high thermal conductivity filler. The amount of filler added may be varied to obtain a desired thermal conductivity for a specific application (e.g., the one or more thermally conductive layer may have a thermal conductivity of more than about 1 W/mK).

The amount of electrical insulation provided by electrically insulating layer 310 and the amount of thermal conductivity provided by thermally conductive layer 320 may be adjusted as desired for specific machine applications. In this example, there are two equally thick layers for a balance of electrical insulation vs. thermal conductivity. It is to be understood that layer 310 may be disposed above or below layer 320. However, the overall insulation layer can be configured for greater or less electrical insulation vs. thermal conductivity by changing the number of layers in each portion. For example, if one requires a greater electrical insulation vs. thermal conductivity ratio, then the number of electrically insulating layers can be increased (e.g., four layers of 310 vs. two layers of 320). Conversely, if one requires a lower electrical insulation vs. thermal conductivity ratio, then the number of thermally conductive layers can be increased (e.g., two layers of 310 vs. three layers of 320).

FIG. 4 illustrates a cross-sectional view of insulating layer 455 having an interleaved configuration of one or more electrically insulating layer 410 and one or more thermally conductive layers 420, according to an aspect of the present invention. This insulating layer 455 may also be used as a turn or ground wall insulation layer. In this example, each electrically insulating layer 410 is interleaved with each thermally conductive layer 420, and both types of layers extend through the full thickness of the insulation layer. This configuration provides improved thermal conductivity (compared to the insulation layer shown in FIG. 2), because the thermally conductive layers extend through the entire thickness of the insulating layer. In this example, an equal number of electrically insulating layers 410 and thermally conductive layers 420 are shown. It is to be understood that one could vary the amount of interleaf between layers (other than that as shown in the FIG. 4), as desired in the specific application.

FIG. 5 illustrates a cross-sectional view of insulating layer 555 having an interleaved configuration of one or more electrically insulating layer 510 and one or more thermally conductive layers 520, according to an aspect of the present invention. This insulating layer 555 may also be used as a turn or ground wall insulation layer. However in this example, a different number of electrically insulating layers 510 are interleaved with the thermally conductive layers 520. Both types of layers extend through the full thickness of the insulation layer. This configuration demonstrates how the insulation layer 555 can be configured for greater or less electrical insulation vs. thermal conductivity by changing the number of layers. For example and as shown, if one requires a greater electrical insulation vs. thermal conductivity ratio, then the number of electrically insulating layers 510 can be increased (e.g., two layers of 510 for every one layer of 520). Conversely, if one requires a lower electrical insulation vs. thermal conductivity ratio, then the number of thermally conductive layers can be increased (e.g., one layer of 310 vs. three layers of 320). Only a few examples have been shown, but it can be seen that a high degree of control exists to tailor the specific electrical insulation vs. thermal conductivity ratio desired by adjusting the number layers in each of the electrically insulating layers 510 and thermally conductive layers 520. It is to be understood that one could vary the amount of interleaf between layers (beyond that as shown in the FIG. 5), as desired in the specific application.

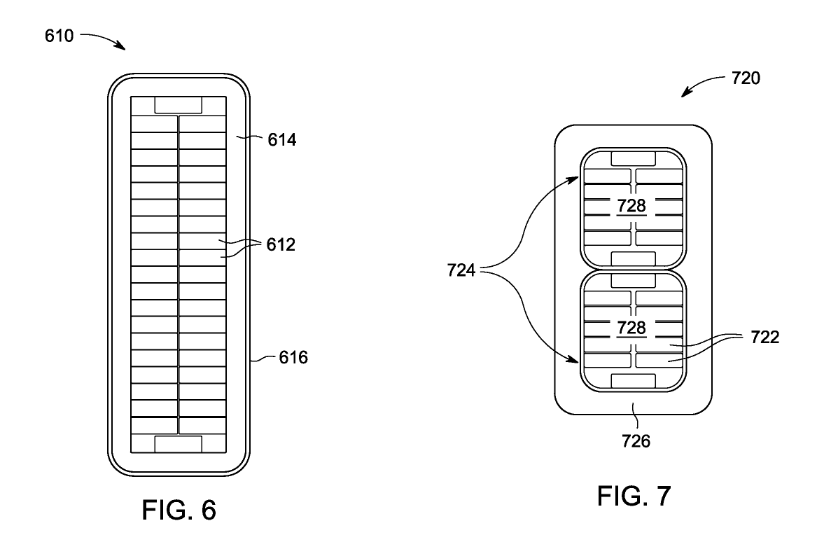

FIG. 6 and FIG. 7 illustrate cross-sectional views of conductor bars 610, 720 in a transposed configuration. This type of configuration is typically referred to as a Roebel bar or configuration. FIG. 6 shows a Roebel-type stator bar having subconductors 612, groundwall insulation 614, and slot corona protection armor 616. FIG. 7 illustrates a two turn Roebel-type stator bar 720 having subconductors 722 (strands or individual subconductors) transposed in the slot portion. Some also transpose the strands in the end arm outboard of slot. The stack of subconductors are wrapped with turn insulation 724, and the turn insulation 724 is then wrapped with ground wall insulation 726. In this example, the insulating system includes an insulation layer 724 positioned about one or more conductors 722. The insulation layer comprises multiple layers including one or more electrically insulating layer and one or more thermally conductive layer as previously described. In this example the insulation layer is configured as turn insulation where the insulation layer is located between individual turns 728 and around individual turns 728. However, it is to be understood that the turn insulation could be located either between individual turns or around individual turns, as desired in the specific application. The high thermal conductivity layer (or one or more thermally conductive layer) could be used as turn insulation alone.

It is to be understood that the insulation layer described herein may be applied to any conductor in any electrical machine. For example, the insulating layer can be used as ground wall insulation in motors or generators, conductor insulation, stator bar insulation, or any other conductor where it is desired to have improved thermal conductivity or a high degree of control in the electrical insulation vs. thermally conductive ratio.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A stator bar, comprising:
a plurality of conductors; and
an insulation layer positioned about the plurality of conductors;
wherein the insulation layer comprises multiple layers, the multiple layers including one or more electrically insulating layer and one or more thermally conductive layer.

2. The stator bar of claim 1, wherein the one or more electrically insulating layer comprises at least one of mica and fiberglass, and the one or more thermally conductive layer comprises at least one of boron nitride (BN), aluminum oxide (Al2O3), aluminum nitride (AlN), silicon nitride (Si3N4), magnesium oxide (MgO), zinc oxide (ZnO), strontium titanate (SrTiO3), titanium dioxide (TiO2), silica (SiO2), or diamond (C).

3. The stator bar of claim 2, wherein the one or more electrically insulating layer comprises mica and the one or more thermally conductive layer comprises at least one of boron nitride (BN) and aluminum oxide (Al2O3).

4. The stator bar of claim 3, wherein the one or more thermally conductive layer comprises a thermal conductivity of more than about 1 W/mK.

5. The stator bar of claim 1, wherein the insulation layer is comprised of a plurality of lapped layers.

6. The stator bar of claim 5, wherein the one or more electrically insulating layer is comprised of one or more lapped layers and the one or more thermally conductive layer is comprised of one or more lapped layers; and
wherein the one or more electrically insulating layer is disposed substantially adjacent to the one or more thermally conductive layer.

7. The stator bar of claim 5, wherein the one or more electrically insulating layer is comprised of one or more lapped layers and the one or more thermally conductive layer is comprised of one or more lapped layers; and
wherein the one or more electrically insulating layer and the one or more thermally conductive layer are interleaved with each other.

8. The stator bar of claim 1, wherein the insulation layer has an electrical insulation vs. thermally conductive ratio configured by a number of the one or more electrically insulating layer and a number of the one or more thermally conductive layer.

9. An insulating system comprising:
an insulation layer positioned about one or more conductors;
wherein the insulation layer comprises multiple layers, the multiple layers including one or more electrically insulating layer and one or more thermally conductive layer.

10. The insulating system of claim 9, wherein the one or more electrically insulating layer comprises at least one of mica and fiberglass, and the one or more thermally conductive layer comprises at least one of boron nitride (BN), aluminum oxide (Al2O3), aluminum nitride (AlN), silicon nitride (Si3N4), magnesium oxide (MgO), zinc oxide (ZnO), strontium titanate (SrTiO3), titanium dioxide (TiO2), silica (SiO2), or diamond (C).

11. The insulating system of claim 10, wherein the one or more electrically insulating layer comprises mica and the one or more thermally conductive layer comprises at least one of boron nitride (BN) and aluminum oxide (Al2O3).

12. The insulating system of claim 11, wherein the one or more thermally conductive layer comprises a thermal conductivity of more than about 1 W/mK.

13. The insulating system of claim 9, wherein the insulation layer is comprised of a plurality of lapped layers.

14. The insulating system of claim 13, wherein the one or more electrically insulating layer is comprised of one or more lapped layers and the one or more thermally conductive layer is comprised of one or more lapped layers; and
wherein the one or more electrically insulating layer is disposed substantially adjacent to the one or more thermally conductive layer.

15. The insulating system of claim 13, wherein the one or more electrically insulating layer is comprised of one or more lapped layers and the one or more thermally conductive layer is comprised of one or more lapped layers; and
wherein the one or more electrically insulating layer and the one or more thermally conductive layer are interleaved with each other.

16. The insulating system of claim 13, wherein the insulation layer has an electrical insulation vs. thermally conductive ratio configured by a number of the one or more electrically insulating layer and a number of the one or more thermally conductive layer.

17. An insulating system comprising:
an insulation layer positioned about one or more conductors;
wherein the insulation layer comprises one or more thermally conductive layer; and wherein the insulation layer is configured as turn insulation where the insulation layer is located in a least one of: between individual turns or around individual turns.

18. The insulating system of claim 17, wherein the one or more thermally conductive layer comprises at least one of boron nitride (BN), aluminum oxide (Al2O3), aluminum nitride (AlN), silicon nitride (Si3N4), magnesium oxide (MgO), zinc oxide (ZnO), strontium titanate (SrTiO3), titanium dioxide (TiO2), silica (SiO2), or diamond (C).

19. The insulating system of claim 18, wherein the one or more thermally conductive layer comprises at least one of boron nitride (BN) and aluminum oxide (Al2O3).

20. The insulating system of claim 17, wherein the one or more thermally conductive layer comprises a thermal conductivity of more than about 1 W/mK, and wherein the insulation layer is comprised of a plurality of lapped layers.
